(19) United States
(12) Patent Application Publication
(10) Pub. No.: US 2015/0154636 A1
(43) Pub. Date: Jun. 4, 2015

(54) Determining online ad targeting information, such as keyword-targeting suggestions

(71) Applicant: Valentin Spitkovsky, Sunnyvale, CA (US)

(72) Inventor: Valentin Spitkovsky, Sunnyvale, CA (US)

(21) Appl. No.: 11/017,424

(22) Filed: Dec. 20, 2004

(51) Int. Cl. G06Q 30/02; G06F 17/30

(52) U.S. Cl. CPC G06Q 30/0256; G06F 17/30342

(57) ABSTRACT

Advertisers can be helped to find good targeting-keywords (or targeting criteria other than targeting keywords). This may be done by generating an index including entries, each of the entries including an association from a first serving constraint to each of one or more serving constraints paired with the first serving constraint (where each of the paired serving constraints are used under at least one common online advertising entity). At least some embodiments consistent with the present invention may accept a seed serving constraint, and generate one or more suggested serving constraints using the seed serving constraint in concert with the index.

### §0. RELATED APPLICATIONS

This application claims benefit to Provisional application Ser. No. __/___,___ , (incorporated herein by reference), titled “DETERMINING ONLINE AD TARGETING INFORMATION, SUCH AS KEYWORD-TARGETING SUGGESTIONS,” filed on Dec. 17, 2004, and listing Valentin Spitkovsky as the inventor.

### §1. BACKGROUND OF THE INVENTION

§1.1 Field of the Invention

The present invention concerns online advertising. In particular, the present invention concerns improving the determination of information used to target the serving of ads, such as targeting-keywords (which may sometimes be referred to simply as “keywords” below) for example.

§1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword relevant advertising has been used by search engines. One example of a query keyword relevant advertising system is the AdWords advertising system by Google of Mountain View, Calif. Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Hark and Paul Bucheit as inventors, and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Bucheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. The AdSense system by Google is an example of a content-relevant advertising system.

In many online ad systems, one or more ads are displayed in association with a document, such as a search results page, or a Webpage with content for example. Typically, online ads include embedded information (e.g., links) such that when the ad is selected (e.g., by a user clicking on the ad), a browser is loaded with a document (e.g., a Webpage) associated with the ad. Such a document is commonly referred to as the “landing page” of the ad.

One problem with targeted ad serving is that it can often be difficult for advertisers to specify appropriate keywords, or some other targeting criteria, for a given ad. Such poor targeting may lead to inappropriate ad serves (“over-serving”), or no ad serves when appropriate (“under-serving”). Moreover, the amount of work involved in determining appropriate targeting keywords may be so daunting to advertisers as to dissuade them from participating in such targeted ad serving systems. Frustrations in determining effective targeting criteria can lead advertisers to reduce their use of an ad serving system, or not to expand their use of an ad serving system.

Currently many advertisers that don't understand how ad systems work and the process of selecting good targeting keywords tend to under-spend, pay third parties to tune their targeting-keywords for them, or even neglect their ads. Many advertisers trying to use online ad serving systems on their own encounter difficulties that lead to bad targeting-keywords and find themselves consuming a lot of time and effort trying to improve their ad performance. Monitoring targeting-keyword performance, especially when performance is segmented by wide and exact coverage, the user's language, geographic location, etc. could easily become a full-time job.

In view of the foregoing, it would be useful to help advertisers find good targeting-keywords. It would similarly be useful to help advertisers find good targeting criteria other than targeting keywords.

### §2. SUMMARY OF THE INVENTION

Embodiments consistent with the present invention may be used to help advertisers find good targeting-keywords (or targeting criteria other than targeting keywords). Such embodiments may do so by generating an index including entries, each of the entries including an association from a first serving constraint to each of one or more serving constraints paired with the first serving constraint, wherein each of the paired serving constraints are used under at least one common online advertising entity. At least some embodiments consistent with the present invention may accept a seed serving constraint, and generate one or more suggested serving constraints using the seed serving constraint in concert with the index.

In at least some embodiment consistent with the present invention, each of the entities may be an online advertisement or a set including a plurality of advertisements (e.g., an ad group, an ad campaign, etc.)

In at least some embodiments consistent with the present invention, attribute(s) may include one or more of a number of impressions, a number of selections, a number of conversions, an amount spent on the entity, etc.

In at least some of embodiments consistent with the present invention, the serving constraint may be a targeting-keyword (broad, phrase, exact, etc.), a targeting-concept, a location, a time, a time range, a day, a day range, a date, a date range, user information, user behavior information, etc.

At least some embodiments consistent with the present invention may analyze entities (e.g., advertisements) that score (e.g., perform) well on certain serving constraints (e.g., keywords), and determine which other serving constraints that the entities score well on.

### §3. BRIEF DESCRIPTION OF THE DRAWINGS

FIG. 1 is a diagram showing parties or entities that can interact with an advertising system.

FIG. 2 is a diagram illustrating an environment in which, or with which, embodiments consistent with the present invention may operate.

FIG. 3 is a bubble diagram illustrating various operations that may be performed, and various information that may be used and/or generated, by embodiments consistent with the present invention.

FIG. 4 is a flow diagram of an exemplary method for building a targeting-keyword suggestion index in a manner consistent with the present invention.

FIG. 5 is a flow diagram of an exemplary method for suggesting targeting-keyword(s) in a manner consistent with the present invention.

FIG. 6 is a block diagram of an exemplary apparatus that may perform various operations and store various information in a manner consistent with the present invention.

### §4. DETAILED DESCRIPTION

The present invention may involve novel methods, apparatus, message formats, and/or data structures for generating online ad targeting information, such as targeting-keyword suggestions, using performance information of targeting information in an advertisement system. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, terms that may be used in the specification are described in §4.1. Then, environments in which, or with which, the present invention may operate are described in §4.2. Thereafter, exemplary embodiments of the present invention are described in §4.3. Then, a specific example illustrating the usefulness of the present invention is provided in §4.4. Finally, some conclusions regarding the present invention are set forth in §4.5.

### §4.1 DEFINITIONS

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications. In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### §4.2 EXEMPLARY ADVERTISING ENVIRONMENTS IN WHICH, OR WITH WHICH, THE PRESENT INVENTION MAY OPERATE

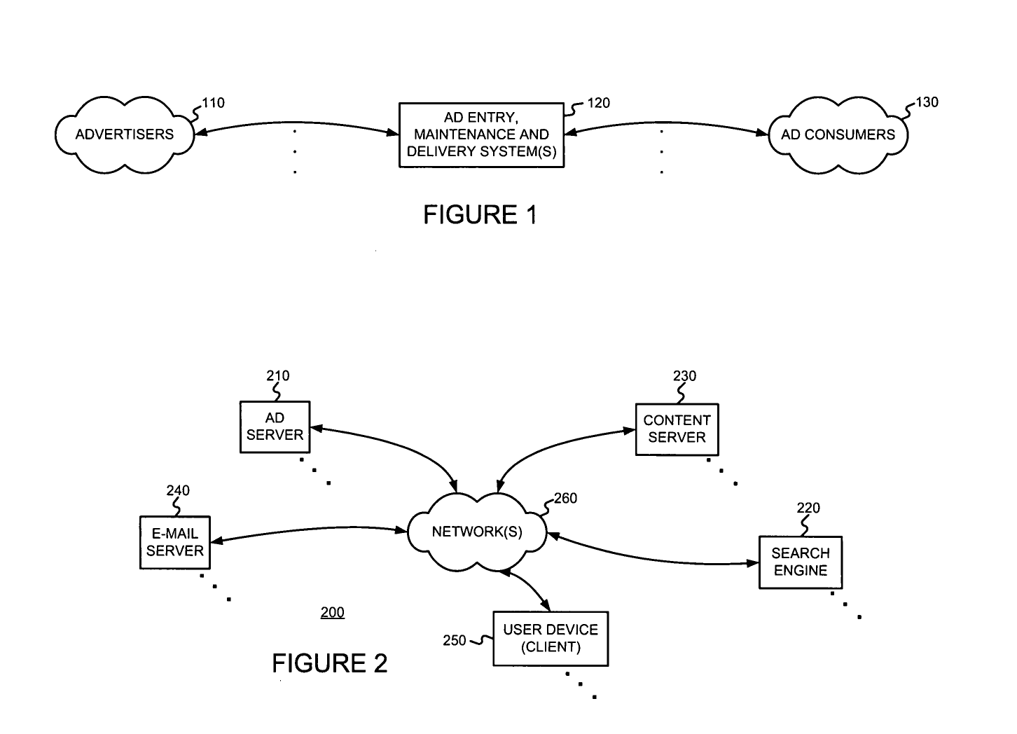

FIG. 1 is a high-level diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or click-through related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., maximum cost (cost per click-though, cost per conversion, etc.)). Alternatively, or in addition, each ad group may include an average cost (e.g., average cost per click-through, average cost per conversion, etc.). Therefore, a single maximum cost and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 210 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application (introduced above), ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, click-through or not, impression time, impression date, size, conversion or not, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, click-through or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### §4.3 EXEMPLARY EMBODIMENTS

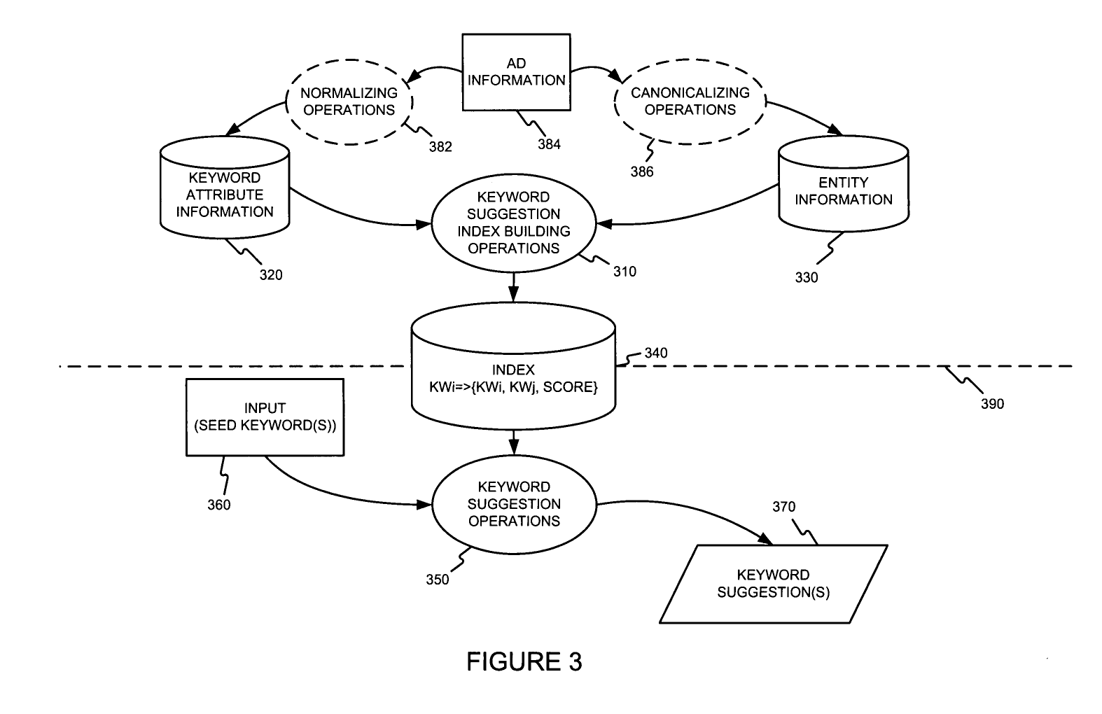

FIG. 3 is a bubble diagram illustrating various operations that may be performed by embodiments consistent with the present invention, and various information that may be used and/or generated by embodiments consistent with the present invention. The index 340 may be used to suggest serving constraints such as targeting-keywords for example. The operations and information above line 390 concern building the index 340, while the operations and information below line 390 concern using the index 340 to suggest serving constraints.

The keyword suggestion index building operations 310 may use both the keyword attribute information 320 and the entity information 330 to build a keyword suggestion index 340 which maps keywords to (e.g., scored) keyword pairs (or simply (scored) keywords). The keyword suggestion operations 350 may accept one or more seed keywords (e.g., from an advertiser) 360 and use them, along with the index 340, to generate one or more suggested keywords 370.

Normalizing operations 382 may be used to normalize keywords obtained from the ad information 384 and save keyword attribute information 320. Canonicalizing operations 386 may be used to canonicalize the ads obtained from the ad information and save them as entity information 330. Each of these operations is described in more detail below.

The ad information 384 may contain information about ads in an online ad serving system. Such information may include performance information (or statistics from which performance information may be derived), such as number of impressions, number of selections, number of conversions, total amount of money spent on the ad, etc. The ad information can be aggregated in different ways to provide different granularities or levels of precision. That is, ad information may be aggregated for various “entities.” Some examples of entities include adgroup_creative, creative, normalized_creative, adgroup, audience (e.g., as grouped by language, ad constraint groupings, etc.), delivery_block (e.g., time interval over which ad is eligible to be served), campaign, account, customer, etc. By defining and selecting an entity, the precision and number of the suggested keywords can be tuned. Generally, the more specific the entity is (such as individual ads), the more precise the keyword suggestions, but the lower the number of suggestions will be. Conversely, in general, the courser the entity is (such as a campaign and accounts), the less precise the keyword suggestions, but the greater the number of such suggestions will be. Statistics and/or performance measures used in the methods described below could be collected and applied at various entity levels such as those mentioned above. The selection of the entity level may involve a trade-off between precision and coverage.

The normalizing operations 382 may reduce various targeting criteria, which may have different IDs, to unified clusters that logically match the same queries. For example, in an exemplary ad serving system, the target “Hotel !” will match the same things as “hotel”, so targeting criteria components such as spacing, capitalization, special characters, etc. may be removed or ignored so that such components are not considered when grouping the keywords that logically match the same queries. Also, in an exemplary ad serving system, the order of terms in keyword types doesn't matter, so those may be normalized as well. Furthermore, in an exemplary ad serving system, phrase types that contain only a single term have the same effect as keyword types, so they may also be merged. This same logic of normalizing can be applied to all keywords obtained from the ad information 384. The normalized keywords, along with their attributes (e.g., impressions, selections, conversions, dollars spent, etc.) may then be stored as keyword attribute information 320. However, it is not necessary that the keyword attribute information 320 be normalized.

The canonicalizing operations 386 may remove or ignore differences in entities that aren't perceived by the end user. For instance, consider two different ads with different destination URLs, but the same visible URL. The destination URL doesn't affect a user's perception of the ad since the user wouldn't see anything different until after they have selected the ad. Hence, ads that would likely be perceived as the same by an end user may be merged and treated as the same ad for the purpose of getting more data (for the merged, canonicalized ad as compared with the individual ads that were merged). Furthermore, ads containing wildcard keyword attributes (i.e., ads having a creative which includes a dynamically inserted keyword) may be dropped, since they may have looked different, depending on what terms were in the query. The canonicalized ads are stored as entity information 330. However, it is not necessary that the entity information 300 be canonicalized.

The keyword suggestion index building operations 310 use entity information 330 and keyword attribute information 320 to build an index 340. For example, the keyword suggestion index building operations 310 may aggregate keywords into clusters at the specified entity level (e.g., all keywords from the same individual ad may be a cluster) and combine statistics (e.g., impressions, selections, conversions, dollars spent, etc.) for each of the keywords within a cluster. Then the keyword suggestion index operations 310 may filter all keywords based on their statistics (e.g., with, either impressions, selections, or dollars set to zero), and eliminate any clusters that end up containing fewer than two keywords. (Clusters containing fewer than two words are dropped since the system cannot discover keyword relationships from a single keyword in a cluster.) Furthermore, the keywords suggestion index building operations 310 may eliminate poorly performing keywords (e.g., those whose selection rate is too low).

After the filtering process has been completed, clusters of normalized and filtered keywords and associated attributes remain (e.g., in the form of {entity, keyword, tuple{impressions, clicks, dollars spent}}). For each cluster of filtered keywords, the keyword suggestion index building operations 310 may produce unique pairs of keywords within each cluster and score them. In some embodiments consistent with the present invention, the pair score (P_score) is the minimum of the scores for the individual keywords, or the minimum of components from which the individual keyword scores are derived. The score for the individual keyword may be determined using attributes (e.g., may simply be the number of selections it got, dollars spent on it, its selection rate, its dollars spent*selection rate, etc.). Hence, the keyword suggestion index building operations 310 may produce an individual pair score for every unique pair within an entity cluster for all entity clusters (entity{Ki, Kj, P_score}). The order of the mapping of the keywords should not matter. Thus, the keyword pairs K1→K2 and K2→K1 within an entity cluster will have the same individual pair score and may be thought of as one unique keyword pair for that entity cluster. For each keyword pair, the scores may then be combined (e.g., summed) across all the entity clusters (e.g., at all possible entity levels) may be to produce a combined pair score (CP_score). For each keyword, a mapping from a paired keyword, perhaps ordered by CP_score, may be used to generate an index. Specifically, for each keyword Ki there may be an ordered and scored list of one or more other keywords Kj (Ki→{Kj, P_score}) that were paired with keyword Ki. This index may be stored as the index 340.

The keyword suggestion operations 350 accept one or more input seed keywords 360 (e.g., entered by an advertiser) and use each of the seed keyword(s) to look up one or more keyword suggestions from the index 340. Thus, for example, an advertiser may enter seed keyword(s) to get keyword suggestions 370 for targeting their ad.

In at least some embodiments consistent with the present invention, some of these seed keywords may have weights associated with them. The keyword suggestion operations 350 may use the index for each of the seed keyword(s) to look up suggestions. Each suggestion may be scored using the keyword combined pair scores and/or the seed keyword weight factors. Finally, the keyword suggestion operations 350 may produce a final flat list of scored keyword suggestions (perhaps with the “seed” keywords removed). An example of operations illustrating the aforementioned is provided in §4.4.

Embodiments consistent with the present invention may analyze entities (e.g., advertisements) that score (e.g., perform) well on certain serving constraints (e.g., keywords), and determine which other serving constraints that the entity does (or entities do) well on.

### §4.3.1 EXEMPLARY METHODS

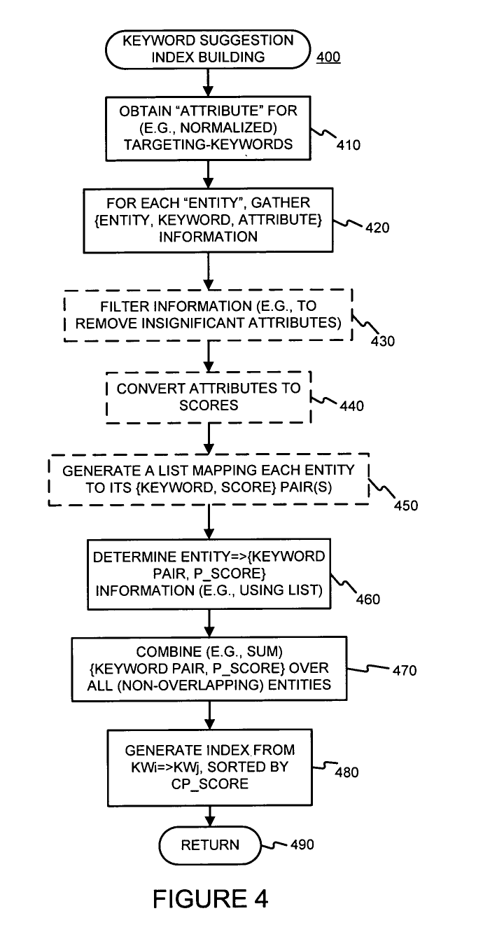

FIG. 4 is a flow diagram of an exemplary method 400 that may be used to build a keyword suggestion index in a manner consistent with the present invention. Basically, for some keyword K, the method 400 may produce a list (e.g., an ordered, and possibly scored list) of suggested keywords. The method 400 may obtain one or more “attributes” (e.g., type of impressions, selections, conversions, dollars spent) for (e.g., normalized) targeting-keywords. (Block 410) For each entity, the method 400 may gather {entity, keyword, attribute} information. (Block 420) This {entity, keyword, attribute} information may then be filtered to remove any keywords having insignificant attributes. (Block 430) Then, the attributes may be converted into scores according to some scoring function. (Block 440) A list mapping each entity to its {keyword, score} pair(s) may then be generated. (Block 450) For each entity, one or more a unique keyword pairs, each with a pair score may be generated. Thus, a list of entity→{keyword pair, P_score} information (where P_score denotes pair score) may be created. (Block 460) The {keyword pair, P_score} information may be combined over all non-overlapping entities to generate one or more associations of keyword pair, and combined pair score (CP_score). (Block 470) Finally, an index for each keyword may be generated. (Block 480) For example, for every keyword, there may be an ordered and scored list of one or more other keywords (e.g., Ki→Kj, CP_score). The method 400 may then be left. (Node 490)

Referring back to block 430, the method 400 may filter information in a variety of ways. For example, it 400 may remove keywords that have zero valued attributes or estimated attribute values in which there is little confidence. Alternatively, or in addition, the method 400 may drop entities containing fewer than two keywords (since no association can be formed from a single keyword).

Referring back to block 440, the method 400 may convert an attribute value to a score according to some scoring function. The scoring function may be as simple using an attribute value itself (e.g., selection rate, number of impressions, amount of money spent, etc.), or may be a function (e.g., linear, polynomial, or exponential) of some combination of attribute values (e.g., selection rate multiplied by the amount of money spent).

Referring back to block 460, for each entity, the method 400 may generate all possible unique keyword pairs and score them according to some scoring function as mentioned above. In at least some embodiments consistent with the present invention, the score is the minimum of the scores for the individual keywords of the keyword pair. If the individual scores are formed from more than one component (e.g., selection rate*money spent), then the keyword pair score will be derived from the minimum of components (MIN{selection rateᵢ, selection rateⱼ}*MIN{money spent, money spentⱼ}). This score is denoted as pair score (P_score).

Referring back to block 470, the method 400 may aggregate all keyword pairs over all non-overlapping entities. In at least some embodiments consistent with the present invention, if a keyword pair found in a first entity is also found in a second entity, these two keyword pairs will be merged as one and their scores will be summed. Summing is just one way of combining scores. Other combination techniques are possible. This process may be performed for all keyword pairs until a complete list of all keyword pairs with pair scores across all entities is determined.

Referring back to block 480, the method 400 now has sufficient information to create an index of suggested keywords for every keyword. Specifically, in at least some embodiments consistent with the present invention, for each keyword, the method 400 may create a list (e.g., an ordered and/or scored list) of other keywords. These scored lists may serve as the keyword suggestions mapped from an input keyword (e.g., a seed keyword input by an advertiser).

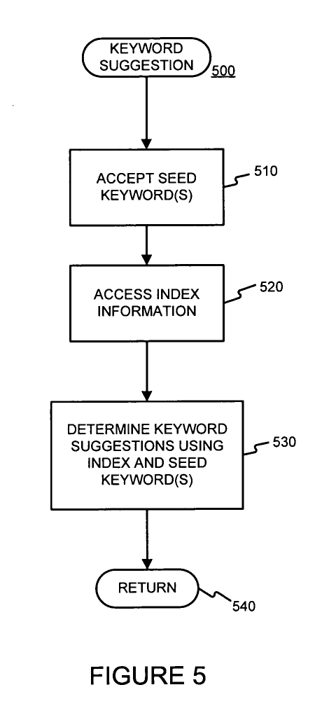

FIG. 5 is a flow diagram of an exemplary method 500 that may be used to suggest one or more keywords in a manner consistent with the present invention. The method 500 accepts one or more seed keywords (e.g., from advertisers) (Block 510) and accesses index information 340. (Block 520) The method 500 may then determine keyword suggestions using the seed keyword(s) and index information (Block 530) before the method 500 is left (Node 540).

Referring back to block 510, the seed keyword(s) may have weights associated with them. The weights may be used to emphasize which keyword is more important and of higher interest to the advertiser. Hence, the system may provide an ordered list of keyword suggestions taking into account the keyword weight factors (e.g., suggested keywords for seed keywords of higher weights may be placed higher on the keyword suggestion list). These weights may be used to help advertisers to express a concept or niche that they want to target their ad to in a way that might be difficult if the keywords were unweighted. The scores of the mappings in the index can be used instead of, or in addition to, the weights.

Referring back to block 530, the method 500 may use each of the one or more seed keywords to search the index information for keyword suggestions. The method 500 may aggregate the keyword suggestion lists to generate a final list of keyword suggestions. Each of the keyword suggestions in the final list may have a final score. The final score may be a function of one or both of (i) the weight of the seed keyword and (ii) the score (of each of) the seed keyword-to-keyword suggestion pair. If the same keyword is suggested by different seed keywords, its score may be increased.

### §4.3.2 EXEMPLARY APPARATUS

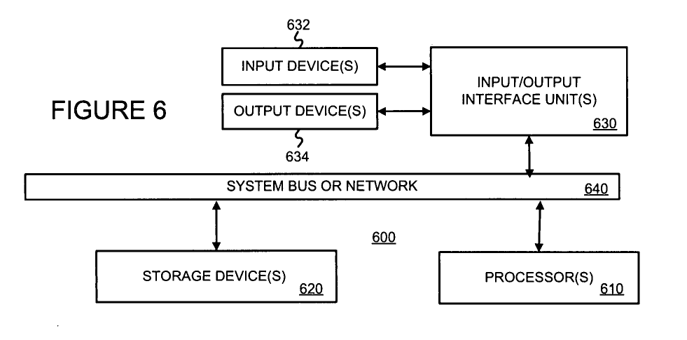

FIG. 6 is block diagram of a machine 600 that may perform one or more of the operations discussed above. The machine 600 may include one or more processors 610, one or more input/output interface units 630, one or more storage devices 620, and one or more system buses and/or networks 640 for facilitating the communication of information among the coupled elements. One or more input devices 632 and one or more output devices 634 may be coupled with the one or more input/output interfaces 630.

The one or more processors 610 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 620 and/or may be received from an external source via one or more input interface units 630.

In one embodiment, the machine 600 may be one or more conventional personal computers. In this case, the processing units 610 may be one or more microprocessors. The bus 640 may include a system bus. The storage devices 620 may include system memory, such as read only memory (ROM) and/or random access memory (RAM). The storage devices 620 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 632, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 610 through an appropriate interface 630 coupled to the system bus 640. The output devices 634 may include a monitor or other type of display device, which may also be connected to the system bus 640 via an appropriate interface. In addition to (or instead of) the monitor, the personal computer may include other (peripheral) output devices (not shown), such as speakers and printers for example.

Referring back to FIG. 2, one or more machines 600 may be used as ad server 210, search engine 220, content server 230, e-mail server 240, and/or user device 250.

### §4.3.3 ALTERNATIVES AND EXTENSIONS

One alternative is to (i) select, for a given keyword k, all entities at the proper granularity (e.g., campaigns, or adgroups, etc) that are targeted using k, and (ii) extract aggregate performance for all other keywords used by the selected entities. Those keywords that performed well (e.g., under the applicable scoring methodology) may be suggested. Although this is a very simple technique, there is a whole spectrum of procedures to embellish it. For instance, the system could select those keywords that on average perform better than k or select only those entities where k itself performs above some threshold.

Variants of collaborative filtering, other than those described above, may be used.

Although many of the exemplary embodiments above were described in the context of targeting-keywords, such embodiments can be used in the context of other serving constraints used to target the serving of ads. Further, in some ad delivery systems, there are different types of keywords. For example, if “Broad Match” targeting keyword or keyword phrase is used, the ad may be served when users search for the keyword, in any order, and possibly along with other terms. The ads may also be served automatically for expanded matches, including plurals and relevant variations. If “Phrase Match” targeting is used, the ad may be served when a user searches on the phrase (with the words in the same order as the phrase), even if the query includes other terms. If “Exact Match” targeting is used, the ad may be served when users search for the specific phrase, without any other terms in the query. If “Negative Keyword” targeting is used (bound to either a phrase or word), the ad will not be served. Thus, embodiments consistent with the present invention may be used to suggest different types of keywords, such as broad, phrase, exact and negative.

### §4.4 EXAMPLE OF OPERATIONS

The following example illustrates general operations performed by an exemplary embodiment consistent with the present invention to provide keyword suggestions. In this example, it is assumed that ad information has been accepted by the system and the keywords have been normalized and the ads canonicalized. The level of precision of the performance information attributes (statistics) is down to individual ads, so the “entities” are considered to be individual ads.

Consider the following individual ads:

### Ad_{—}1:

| Keyword: | Car | Automobile | Used | Lease |
|---|---|---|---|---|
| Impressions | 1000 | 1000 | 3000 | 2000 |
| Selections | 50 | 5 | 45 | 40 |
| CTR: | 0.050 | 0.005 | 0.015 | 0.020 |
| Dollars Spent: | 100 | 10 | 35 | 45 |

### Ad_{—}2:

| Keyword: | Car | Lease | Used | Finance |
|---|---|---|---|---|
| Impressions | 1000 | 2000 | 2500 | 4000 |
| Selections | 55 | 44 | 25 | 112 |
| CTR: | 0.055 | 0.022 | 0.010 | 0.028 |
| Dollars Spent: | 110 | 70 | 20 | 90 |

### Ad_{—}3:

| Keyword: | Car | Lease | Finance |
|---|---|---|---|
| Impressions | 1500 | 1800 | 3600 |
| Selections | 90 | 54 | 137 |
| CTR: | 0.06 | 0.030 | 0.038 |
| Dollars Spent: | 120 | 50 | 60 |

### Ad_{—}4:

| Keyword: | Finance | Lease | Rent | Used |
|---|---|---|---|---|
| Impressions | 800 | 3000 | 1000 | 2200 |
| Selections | 20 | 66 | 5 | 88 |
| CTR: | 0.025 | 0.022 | 0.005 | 0.04 |
| Dollars Spent: | 40 | 35 | 5 | 50 |

Since the entities and keywords are available, next step is to create all possible unique keyword pairs and score them within each entity. To score the keyword pairs, a scoring function is defined. It is assumed in this example that the scoring function is the click-through rate multiplied by the dollars spent (CTR*Dollars Spent). Since the scoring function is composed of two components (CTR and Dollars Spent), when scoring the keyword pairs the minimum of the two components of the individual keywords will be used when generating the pair score value.

Based on the foregoing, the following keyword pairs are formed under each entity. Recall that the order of the keywords in the keyword pair does not affect the score (but may affect populating the index). (Note KW_pair denotes keyword pair and P_score denotes pair scores. Only calculations for the P_score of the first entity (Ad_{—}1) are shown.)

Entity_{—}1 (referring to Ad_{—}1)
{KW_pair: car-automobile; P_score: 0.05=0.005*10}
{KW_pair: car-used; P_score: 0.525=0.15*35}
{KW_pair: car-lease; P_score: 0.9=0.02*45}
{KW_pair: used-automobile; P_score: 0.05=0.005*10}
{KW_pair: used-lease; P_score: 0.525=0.15*35}
{KW_pair: automobile-lease; P_score: 0.05=0.005*10}
Entity_{—}2 (referring to Ad_{—}2)
{KW_pair: car-lease; P_score: 1.54}
{KW_pair: car-used; P_score: 0.2}
{KW_pair: car-finance; P_score: 2.52}
{KW_pair: lease-used; P_score: 0.2}
{KW_pair: lease-finance; P_score: 1.54}
{KW_pair: used-finance; P_score: 0.2}
Entity_{—}3 (referring to Ad_{—}3)
{KW_pair: car-lease; P_score: 1.5}
{KW_pair: car-finance; P_score: 2.28}
{KW_pair: lease-finance; P_score: 1.5}
Entity_{—}4 (referring to Ad_{—}4)
{KW_pair: finance-lease; P_score: 0.77}
{KW_pair: finance-rent; P_score: 0.025}
{KW_pair: finance-used; P_score: 1}
{KW_pair: lease-rent; P_score: 0.025}
{KW_pair: lease-used; P_score: 0.77}
{KW_pair: rent-used; P_score: 0.025}

All keyword pairs are now aggregated over all non overlapping entities and an index is created. Specifically, for each keyword, an ordered and scored list of other keywords is created. After going through the aforementioned procedure, the following index of keyword suggestions is created (Only calculations for the first set of pairs are shown.):

| | Suggested | |
|---|---|---|
| Keyword | Keyword | CP_Score |
| Car→ | Finance | 4.80 = 2.52 + 2.28 |
| | Lease | 3.94 = 0.9 + 1.54 + 1.5 |
| | Used | 0.725 = 0.525 + 0.2 |
| | Automobile | 0.05 |

| | Suggested | |
|---|---|---|
| Keyword | Keyword | CP_Score |
| Used→ | Lease | 1.5 |
| | Finance | 1.2 |
| | Car | 0.725 |
| | Automobile | 0.05 |
| | Rent | 0.025 |

| | Suggested | |
|---|---|---|
| Keyword | Keyword | CP_Score |
| Lease→ | Car | 3.94 |
| | Finance | 3.81 |
| | Used | 1.50 |
| | Automobile | 0.05 |
| | Rent | 0.025 |

| | Suggested | |
|---|---|---|
| Keyword | Keyword | CP_Score |
| Finance→ | Car | 4.80 |
| | Lease | 3.81 |
| | Used | 1.2 |
| | Rent | 0.025 |

| | Suggested | |
|---|---|---|
| Keyword | Keyword | CP_Score |
| Automobile→ | Car | 0.05 |
| | Used | 0.05 |
| | Lease | 0.05 |

| | Suggested | |
|---|---|---|
| Keyword | Keyword | CP_Score |
| Rent→ | Finance | 0.025 |
| | Lease | 0.025 |
| | Used | 0.025 |

Complete indexes of suggested keywords now exist. Now, assume that an advertiser inputs the following seed keywords (with equal weights) into the system requesting keyword suggestions.

### {Seed Keyword: Used}

### {Seed Keyword: Lease}

Keyword suggestion operations may use the index information and the seed keywords to produce a scored list of suggested keywords. Specifically, the following keyword suggestion lists are taken from the index information:

| | Suggested | |
|---|---|---|
| Keyword | Keyword | Score |
| Used→ | Lease | 1.5 |
| | Finance | 1.2 |
| | Car | 0.725 |
| | Automobile | 0.05 |
| | Rent | 0.025 |

| | Suggested | |
|---|---|---|
| Keyword | Keyword | Score |
| Lease→ | Car | 3.94 |
| | Finance | 3.81 |
| | Used | 1.50 |
| | Automobile | 0.05 |
| | Rent | 0.025 |

The system may now aggregate the lists by summing the scores of same suggested keywords (excluding any seed keyword) found in both lists and ordering a final list according to score values. In this example, the following list of keyword suggestions, scored and ordered by score, are obtained:

| | | |
|---|---|---|
| Suggested Keywords→ | Finance | 5.01 = 1.2 + 3.81 |
| | Car | 4.67 = 0.725 + 3.94 |
| | Automobile | 0.1 = 0.05 + 0.05 |
| | Rent | 0.05 = 0.025 + 0.025 |

The above keyword suggestion list indicates that the strongest keywords to be used for the particular seed keywords are “finance” and “car” followed by the weaker keywords “automobile” and “rent.” The scores may be presented to the advertiser in conjunction with the targeting-keyword suggestions.

### §4.5 CONCLUSIONS

In view of the foregoing, the present invention allows the generation of keyword suggestions by analyzing correlations between performances of keywords in an ad database. Hence, advertisers may get keyword suggestions by simply making requests, thus eliminating the need to devote substantial effort for manually finding good keywords.

1. A computer-implemented method comprising:
a) for each of a plurality of online advertising entities, obtaining, by a computer system including at least one computer, at least two serving constraints and one or more attribute values associated with each of the at least two serving constraints, each of the one or more attribute values being at least one of a number of impressions associated with the serving constraints of the online advertising entity, a number of selections associated with the serving constraints of the online advertising entity, a number of conversions associated with the serving constraints of the online advertising entity, or an amount spent associated with the serving constraints of the online advertising entity;
b) for each of the plurality of online advertising entities,
i) determining, by the computer system, one or more serving constraint pairs, and
ii) determining, by the computer system, a pair score value for each of the one or more serving constraint pairs by processing each of the one or more attribute values associated with each of the individual serving constraints of the serving constraint pairs and using at least one of the one or more attribute values associated with each of the individual serving constraint pairs;
c) for each of the serving constraint pairs, determining, by the computer system, a combined pair score value across all of the plurality of online advertising entities using the determined pair score values; and
d) generating, by the computer system, an index including entries, each of the entries including an association from a first serving constraint to each of the one or more serving constraints paired with the first serving constraint.

2. The computer-implemented method of claim 1 wherein the entries of the index are ordered based on the first serving constraint.

3. The computer-implemented method of claim 1 wherein each of the associations from the first serving constraint to each of the one or more serving constraints paired with the first serving constraint is ordered based on the combined pair score values of the serving constraint pairs.

4. The computer-implemented method of claim 1 wherein each of the associations from the first serving constraint to each of the one or more serving constraints paired with the first serving constraint includes the combined pair score value of the serving constraint pair.

5. The computer-implemented method of claim 1 wherein each of the online advertising entities is an online advertisement.

6. The computer-implemented method of claim 1 wherein each of the online advertising entities is a set including a plurality of online advertisements.

7. The computer-implemented method of claim 6 wherein each of the sets is an ad group.

8. The computer-implemented method of claim 7 wherein each of the sets is an ad campaign.

9. The computer-implemented method of claim 1 wherein the one or more attribute values include a number of impressions associated with the serving constraints of the online advertising entity.

10. The computer-implemented method of claim 1 wherein the one or more attribute values include a: number of selections associated with the serving constraints of the online advertising entity.

11. The computer-implemented method of claim 1 wherein the one or more attribute values include a number of conversions associated with the serving constraints of the online advertising entity.

12. The computer-implemented method of claim 1 wherein the one or more attribute values include an amount spent associated with the serving constraints of the online advertising entity.

13. The computer-implemented method of claim 1 wherein the serving constraint is a targeting-keyword.

14. The computer-implemented method of claim 1 wherein the serving constraint is a targeting-concept.

15. The computer-implemented method of claim 1 wherein the serving constraint is a location.

16. The computer-implemented method of claim 1 wherein the serving constraint is one of a time, a time range, a day, a day range, a date and a date range.

17. The computer-implemented method of claim 1 wherein the serving constraint includes user information.

18. The computer-implemented method of claim 1 wherein the serving constraint includes user behavior information.

19. The computer-implemented method of claim 1, further comprising:
e) accepting, by the computer system, a seed serving constraint;
f) generating, by the computer system, one or more suggested serving constraints using the seed serving constraint in concert with the index; and
g) outputting, by the computer system, the one or more suggested serving constraints for presentation to a user.

20-36. (canceled)

37. Apparatus comprising:
a) at least one processor;
b) an input device; and
c) at least one storage device storing a computer executable code which, when executed by the at least one processor, performs a method of
1) obtaining, for each of a plurality of online advertising entities, at least two serving constraints and one or more attribute values associated with each of the at least two serving constraints, each of the one or more attribute values being at least one of a number of impressions associated with the serving constraint of the online advertising entity, a number of selections associated with the serving constraint of the online advertising entity, a number of conversions associated with the serving constraint of the online advertising entity, or an amount spent associated with the serving constraint of the online advertising entity,
2) for each of the plurality of online advertising entities,
(A) determining one or more serving constraint pairs,
(B) determining a pair score value for each of the one or more serving constraint pairs by processing each of the one or more attribute values associated with each of the individual serving constraints of the serving constraint pairs and using at least one of the one or more attribute values associated with each of the individual serving constraint pairs,
3) determining, for each of the serving constraint pairs, a combined pair score value across all of the plurality of online advertising entities using the determined pair score values, and
4) generating an index including entries, each of the entries including an association from a first serving constraint to each of One or more serving constraints paired with the first serving constraint.

38. Apparatus comprising:
a) at least one processor;
b) an input device; and
c) at least one storage device storing a computer executable code which, when executed by the at least one processor, performs a method of
1) generating an index including entries, each of the entries including an association from a first serving constraint to each of one or more serving constraints paired with the first serving constraint and a score value derived from one or more attribute values associated with each of the first serving constraint and the one or more serving constraints, wherein each of the paired serving constraints are used under at least one common online advertising entity,
2) accepting a seed serving constraint,
3) generating one or more suggested serving constraints using the seed serving constraint in concert with the index, wherein the associations from the first serving constraint to each of one or more serving constraints paired with the first serving constraint are ordered using one or more attribute values associated with each of the paired serving constraints, each of the one or more attribute values being at least one of a number of impressions associated with a serving constraint of the common online advertising entity, a number of selections associated with the serving constraint of the common online advertising entity, a number of conversions associated with the serving constraint of the common online advertising entity, or an amount spent associated with the serving constraint of the common online advertising entity.

39. (canceled)

40. The computer-implemented method of claim wherein the act of determining, by the computer system, the pair score value for each of the one or more serving constraint pairs determines the pair score value using at least one of (1) a minimum of values of the one or more attribute values associated with the serving constraints, or (2) a minimum of values of two or more different types of attribute values associated with the serving constraints.

41. The computer-implemented method of claim 1, wherein the act of determining a pair score value for each of the one or more serving constraint pairs (1) determines a candidate score value for each of the serving constraints of the serving constraint pair, and (2) selects a minimum of the candidate score values as the pair score value.

42. The computer-implemented method of claim 1, wherein each of the serving constraints has at least two different attributes, each of the two different attributes having an attribute value, and
wherein the act of determining a pair score value for each of the one or more serving constraint pairs (1) selects, for each of the at least two different attributes, a minimum attribute value of the attribute from among the attribute values of the attribute of the serving constraints, thereby selecting a minimum attribute value for each of the at least two different attributes, and (2) determining the attribute pair score value as a function of the selected at least two minimum attribute values for the at least two different attributes.

43. The computer-implemented method of claim 1, wherein the act of determining a pair score value for each of the one or more serving constraint pairs includes determining a product of two of the attribute values.
